(19) United States
(12) Patent Application Publication
(10) Pub. No.: US 2008/0007187 A1
(43) Pub. Date: Jan. 10, 2008

(54) METHOD AND APPARATUS FOR DC SWITCHING LAMP DRIVER

(76) Inventor: Mehrdad Zomorrodi, West Hills, CA (US)

Correspondence Address: CHRISTIE, PARKER & HALE, LLP, PO BOX 7068, PASADENA, CA, 91109-7068, US

(21) Appl. No.: 11/774,524

(22) Filed: Jul. 6, 2007

Related U.S. Application Data
(60) Provisional application No. 60/819,281, filed on Jul. 6, 2006.

(51) Int. Cl. H05B 41/36

(52) U.S. Cl. 315/291

(57) ABSTRACT

A method and electronic circuit for driving multiple backlight lamps by means of DC switching, that is, current switching with single DC high voltage source. The inverter of the present invention does not need any transformers, because it uses an unregulated DC high voltage power supply. The electronic circuit includes a high voltage DC source; a controllable current source; a pair of complementary digital signals; a pair of differential switches controlled by the pair of complementary digital signals for providing a bidirectional current from the current source to the lamp; and a pair of active loads couple to the pair of differential switches, respectively for providing an alternating voltage across the lamp responsive to the complementary digital signals.

### CROSS-REFERENCE TO RELATED APPLICATION(S)

This patent application claims the benefit of the filing date of U.S. Provisional Patent Applications Ser. No. 60/819,281, filed Jul. 6, 2006, and entitled “METHOD AND APPARATUS FOR DC SWITCHING LAMP DRIVER,” the entire content of which is hereby expressly incorporated by reference.

### FIELD OF THE INVENTION

The present invention is directed to a method and apparatus for driving multiple backlight lamps by means of Direct Current (DC) switching, that is, current switching with single DC high voltage source.

### BACKGROUND

Backlight inverters are used in Liquid Crystal Displays (LCD) monitors. FIG. 1 shows a conventional backlight lamp inverter. A pair of FET transistors 1 and 2 in combination with the primary winding (P) of the transformer T1 and capacitor 3 invert the DC voltage of VBATTERY signal (typically 12 volt) to a sinusoidal signal with typical frequency of 50 KHz.

This signal then transforms to a sinusoidal signal with a higher voltage of about 2000 Volts at the secondary winding (S) of T1 transformer which strikes the lamp 5 and sustains the current through the lamp by means of ballast capacitor 4.

Resistor 6 and capacitors 7 and 8 sense the voltage and the current of the lamp and input the sensed signal to a controller device 9. The controller device 9 takes the VMonitor, IMonitor and other system control signals such as VSync, Enable, and Brightness (BRITE) signals. The output of controller device is shown as a pulse, which its width depends on the control signal and this signal modulates the sine wave so that the wider the pulse width the more the energy and therefore the brighter the lamp will be. In this method, in order to control each lamp independent from other lamps, one needs as many transformers and controllers as the number of lamps. In applications such as HDTV and large screen LCD monitors the number of lamps grow to 16, 32 or higher numbers. Their length and therefore their striking voltage and sustaining voltage are also increases. In these applications, the use of several transformers and controller devices prove to be bulky, power consuming, expensive and impractical.

Recently, techniques have been developed that use only one transformer per multiple lamps. (See, for example, U.S. Pat. No. 6,980,053). For example, FIG. 2 shows a circuit in which each eight lamps need only one transformer T1 to drive and control the light of the eight lamps. The main difference compared to the circuit of FIG. I is the addition of the high voltage Alternative Current (AC) programmable lamp current source 31.

FIG. 3 shows a typical circuit for the high voltage AC programmable lamp current source. This circuit works as a current source supplying the lamp with constant current while the high voltage AC is applied across the lamp. Transformer T1 generates 1000 Volts peak, for example, a sine wave which is applied to the Cold Cathode Fluorescent Lamp (CCFL) in series with capacitor C. The capacitor C is called Ballast capacitor and serves to regulate the voltage V1 across the CCFL lamp during the initial lighting of the lamp. Four diodes (D1 to D4) direct the current through the lamp in two different directions in each half cycle of the sine wave.

In other words, in one half cycle, the current enters from the bottom (L1) of the lamp and leaves the lamp from the top (L2) and in next half cycle, the current flows in an opposite direction. Therefore, the circuit creates a bidirectional current through the lamp. High voltage transistors HQ1 and HQ2 form a current mirror. Incoming controlling current generated by the system goes through Diode D5 and HQ1 and gets mirrored to HQ2. The role of D5 is to protect the rest of the system from any surge from this circuit back to the system.

The operation of the circuit can be described in two half cycles of the sine wave generated by the T1 transformer, as shown in FIG. 4. In the first half cycle when V1 is positive, Diodes D1 and D2 turn ON and a path is made for the current set by the current mirror to enter the lamp from the bottom and exiting from the top of the lamp. During the second half cycle, V1 becomes negative and hence D3 and D4 turn ON and D1 and D2 turn OFF. As a result, during this period the current set by the current mirror flows through the lamp by means of D3 and D4 and HQ2.

This method also suffers from the fact that it still needs a high voltage transformer which is bulky and cannot be very reliable at reasonable consumer prices, at the required high frequencies.

Therefore, there is a need for a low cost and small reliable driver.

### SUMMARY

In one embodiment, the present invention is a method and differential electronic circuit for driving a backlight lamp with a high voltage DC source. The method and the electronic circuit include: generating two complementary digital signals; controlling a pair of switches by the two generated complementary digital signals; applying a high DC voltage from the high voltage DC source to the lamp through the pair of switches; and supplying a controllable current through the lamp.

In one embodiment, the present invention is a differential electronic circuit for driving a backlight lamp with a high voltage DC source. The electronic circuit includes a high voltage DC source; a controllable current source; a pair of complementary digital signals; a pair of differential switches controlled by the pair of complementary digital signals for providing a bidirectional current from the current source to the lamp; and a pair of active loads couple to the pair of differential switches, respectively for providing an alternating voltage across the lamp responsive to the complementary digital signals.

### BRIEF DESCRIPTION OF THE DRAWINGS

FIG. 1 shows a conventional backlight lamp inverter.

FIG. 2 shows a circuit in which each eight lamps need only one transformer.

FIGS. 3 and 4 respectively show a typical circuit for the high voltage AC programmable lamp current source and its corresponding timing diagram.

FIG. 5 shows an exemplary block diagram of a DC switching inverter, according to one embodiment of the present invention.

FIG. 6A is an exemplary circuit diagram and FIG. 6B is a corresponding timing diagram of an inverter, according to one embodiment of the invention.

FIG. 7A is an exemplary circuit diagram for producing differential switching signals, and FIG. 7B is a corresponding timing diagram, according to one embodiment of the invention.

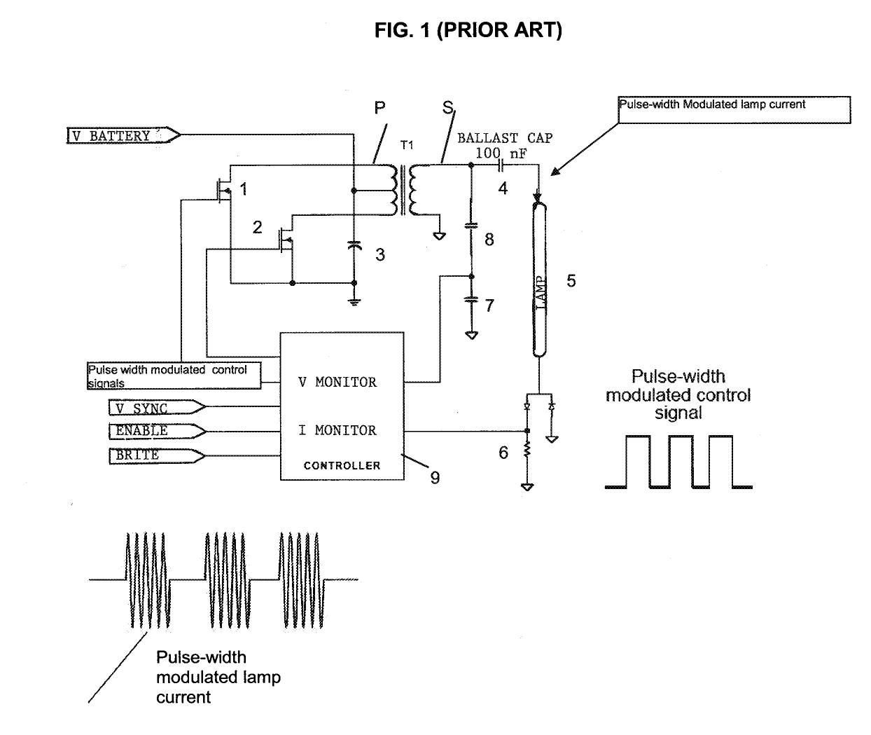

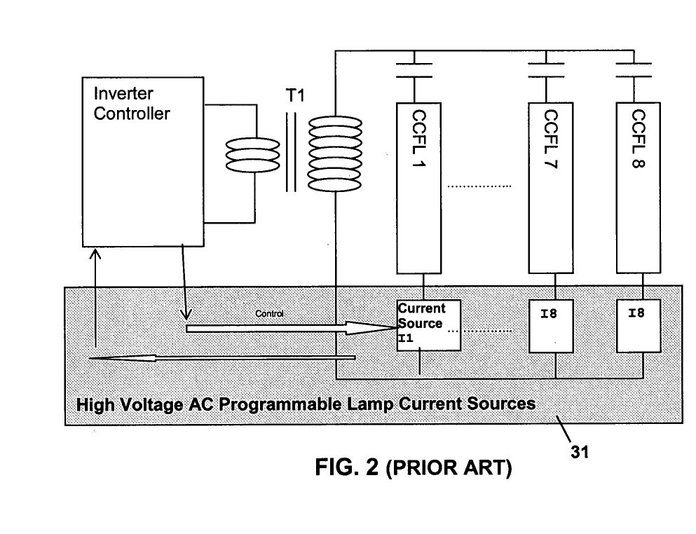

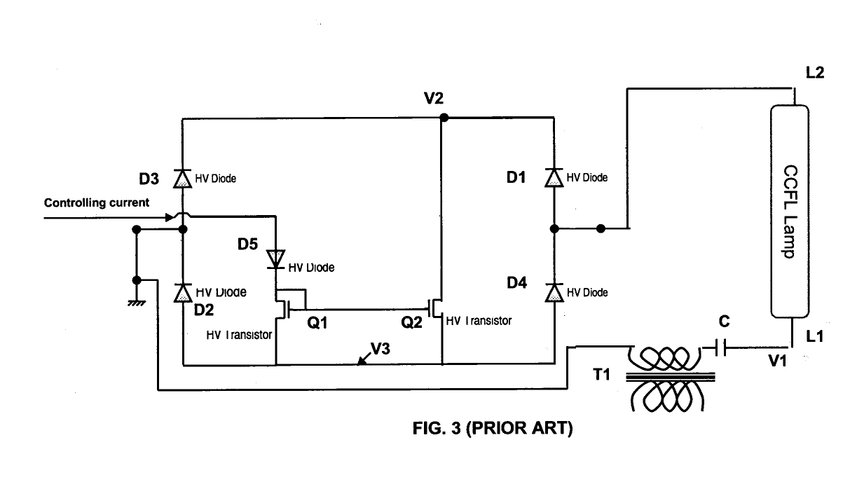

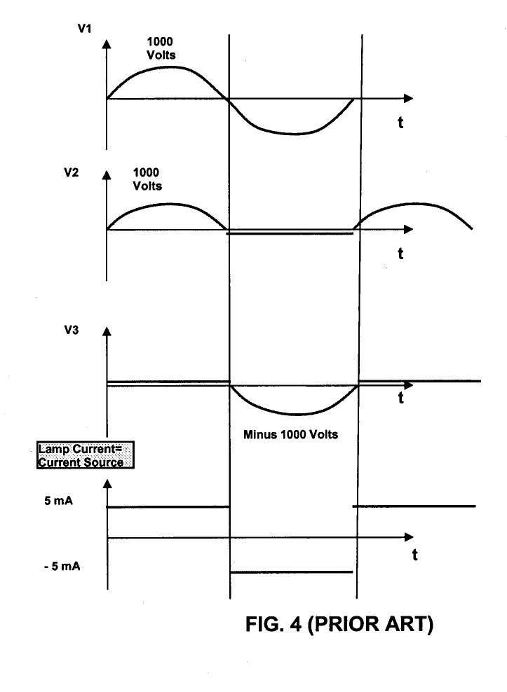

### DETAILED DESCRIPTION

In some embodiments, the present invention is a method and apparatus for driving multiple backlight lamps by means of DC switching, that is, current switching with single DC high voltage source. The inverter of the present invention does not need any transformers, because it uses an unregulated DC high voltage power supply. The inverter includes simple current switching transistors which can turn on and sustain the current and thus the light in the lamps. The inverter of the present invention may be used in a differential mode or in a single-ended mode. If the invention is used in differential mode, the current flows through the lamp bi-directionally which in turn endures the life of the lamp and improves the light uniformity. The new inverter may include active or passive load. In the case of an active load, a simple high voltage N-type Field Effect Transistor (N-FET) in conjunction with a high side N-FET driver provides power factor corrections for higher power efficiency. Switching control signals in the form of Pulse Width Modulation (PWM), controls the dimming and/or light uniformity among the lamps. The invention also includes DC bias current for control of individual lamps to further compensate for temperature and aging of the lamps and hence increase the useful life of the lamps.

The present invention can provide differential-ended or single-ended driver configuration. In case of a differential-ended driver configuration, the effect of parasitic capacitances is canceled. Parasitic capacitances at the leads of the lamp are major deficiency design factors in conventional inverters with conventional circuits using transformers.

In one embodiment, the present invention provides an inverter to drive multiple lamps powered by a DC high voltage power source by means of switching the voltage alternately across the lamp while the current through the lamp is set by a current source.

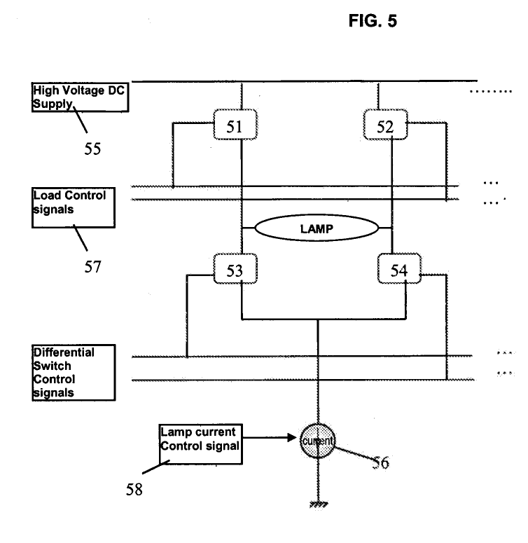

FIG. 5 shows an exemplary block diagram of a switching inverter, according to one embodiment of the present invention. Devices 51 and 52 are loads for the switches 53 and 54, which connect the high voltage DC power supply 55 to the lamp. A current source 56 determines the total current of the lamp and thus the brightness of the lamp.

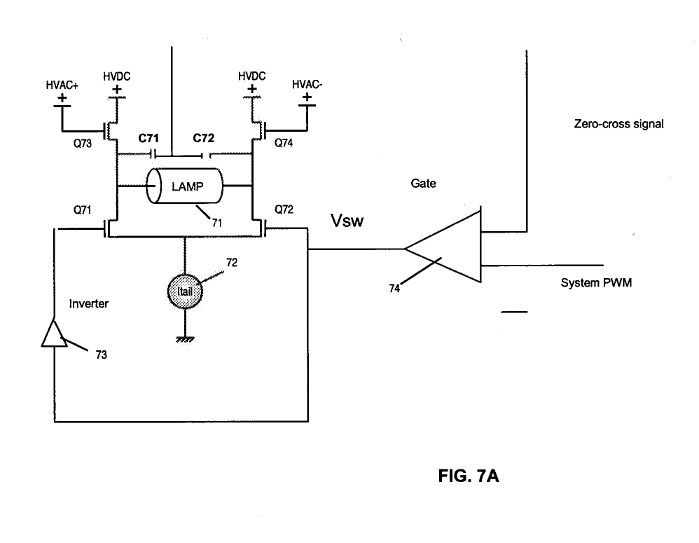

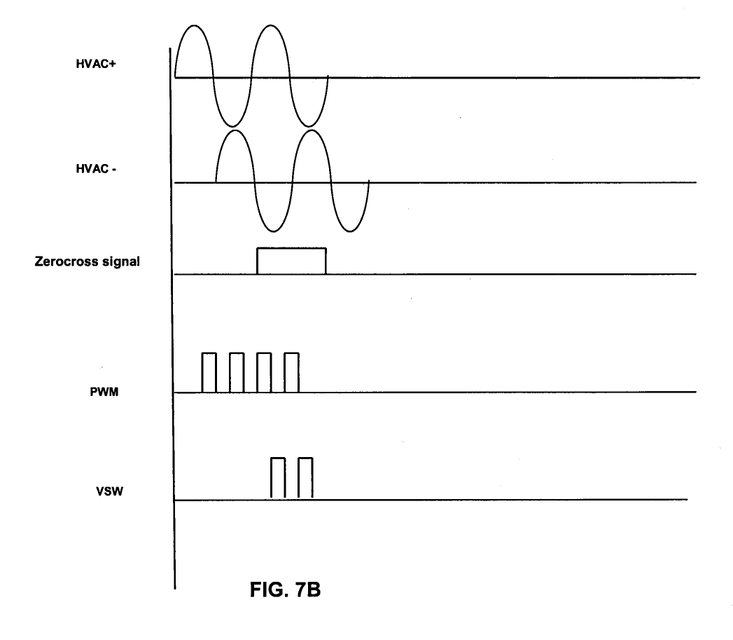

Optional load control signals 57 may be used to further improve the efficiency of the inverter and power factor correction. An exemplary circuit for producing load control signals is shown in FIG. 7A and described below.

The Lamp Current control signal 58 is the main control for the brightness of the lamp. This signal can be generated through various known methods, for example, a Digital-to-Analog Converter (DAC). A ballast capacitor may be placed in series with the lamp to filter the excess voltage across the loads.

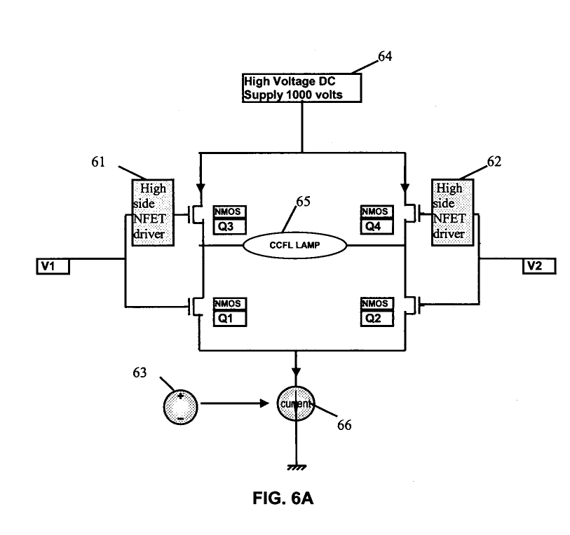

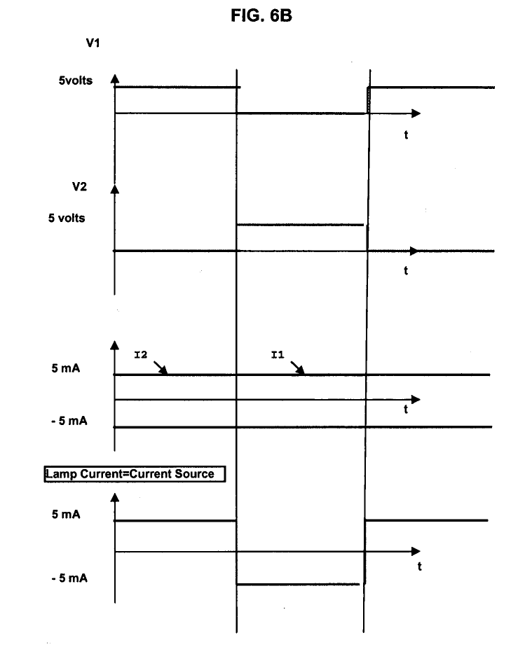

A theory of operation of the DC Switching Inverter is described in the exemplary circuit shown in FIG. 6, which is one possible implementation of the block diagram of FIG. 5.

FIG. 6A is an exemplary circuit diagram and FIG. 6B is a corresponding timing diagram of an inverter, according to one embodiment of the invention. As shown, a pair of high voltage NMOS transistors Q1 and Q2 function as differential switches which are driven with two complementary low voltage pulses, V1 and V2 at their gates as switching control signals. V1 and V2 are low voltage digital pulses and are generated by means similar to other conventional inverters. In the exemplary embodiment shown in FIG. 6B, V1 and V2 are shown to be 5 volt pulses. In one embodiment, the power source is a rectified regulated high voltage DC supply, for example, 1000 Volts DC.

Two high voltage NMOS transistors, Q3 and Q4 in conjunction with two High Side N-FET drivers 61 and 62 are used as active loads. A High Side N-FET driver is a commercially available (NMOS) level shifter that drives the high voltage N-FET active load without a need for a high voltage input. Using the NMOS transistors as the active loads makes it easier to manufacture a circuit according to some embodiments of the invention in a single Integrated Chip (IC). In this exemplary circuit, Load Control signals are shown to be driven by the same V1 and V2 signals for the sake of simplicity. However, the Load Control signals may be driven by other circuitry to minimize power consumption and noise. In some inverter applications, the gates of Q1, Q2, Q3 and Q4 may be driven by signals generated from a feedback signal processing system to increase the efficiency and perform Power Factor Correction due to variations in lamp loading characteristics.

The tail current source 66 in its simplest form can be a low voltage NMOS transistor which its gate is driven by the output of a Digital-to-Analog Converter (DAC) 63.

One cycle of the operation of the inverter is now described referring to the timing diagram in FIG. 6B. In the first half cycle when V1 is 5 Volts and V2 is at zero Volts, Q1 and Q4 are ON and Q2 and Q3 are OFF, therefore, a current path is formed from the power supply through Q4, CCFL lamp 65, Q1 and finally, the current source 66. The value of this current is dictated by the current source 66, which is about 5 mA in this example. In the second half cycle, when V2 is at 5 Volts and V1 is at zero Volts, the transistors Q2 and Q3 are ON and Q1 and Q4 are OFF, therefore, the current path is formed from the power supply through Q3, lamp 65, Q2 and finally, the current source. The value of the lamp current is about −5 mA in this example.

As a result, this circuit establishes a differential switching scheme which generates bidirectional current through the lamp. In one embodiment, the invention can be simplified by eliminating half of the circuitry to have a single ended driver which its current through the lamp would be unidirectional in that case. This way, the operation and the circuit would be simplified and the lamp still lights up, however, the life expectancy of the lamp will be reduced due to the uni-directional current flowing through the lamp.

In one embodiment, the method of the present invention includes generating two complementary digital signals, controlling a pair of complementary switches by the two complementary digital signals, alternatively applying a high DC voltage to the lamp, and alternatively supplying a constant current thru the lamp.

The method and apparatus of the present invention may be used in a LCD monitor, for example, as following. A high voltage DC power supply is energized by plugging the device in power plug. Then, a system microcontroller digitally turns on the tail current source and appropriates voltages to the loads and the gates of the switches (Q1 and Q2). At this time, the high voltage is supplied to the lamp to be lit and then through the alternative switching, the lamp sustains the light. Once the lamp is lit, this light through means of optics illuminates the back of the LCD panel. The pixels of LCD which form the image then appear as differently colored lights on the screen.

An exemplary method and apparatus for producing load control signals and differential switching control signals for a DC switching inverter to perform a power phase alignment are now described. For example, referring to FIG. 5, differential switch control signals 57 can control the timing and the duration of the time that current is flown through the lamp and align it to the timing of the voltage polarity change across the lamp.

An exemplary embodiment of this method and apparatus is shown in FIG. 7A. In this embodiment, the load control signals are driven by alternating high voltage sine waves of HVAC+ (positive phase AC high voltage) and HVAC− (negative phase AC high voltage). A HVDC (DC high voltage) power supply delivers the current determined by Itail 72 through the lamp 71. The switching of the current from positive phase to negative phase is implemented through transistors Q71 and Q72.

A signal, Vsw (Switch Control Signals) provides the proper timing. The signal Vsw is produced based on the timing that the voltage across the lamp is changing its polarity due to HVAC+ and HVAC signals changing direction.

FIG. 7B shows an exemplary timing diagram for the load control signals and the differential switching control signals. The center tap of the capacitors C71 and C72 senses the crossing of the voltage polarity across the lamp 71, and a gate 74, such a comparator or an AND gate, generates the Vsw signal, based on timing of the lamp voltage polarity change. The duration of the Vsw signal is determined by a pulse width modulation control signal (PWM signal), which can be generated by the system.

As shown in FIG. 7B, a Zerocrossing signal is high when the differential voltage across the lamp changes its polarity, which happens when the voltage across the lamp is approximately zero. The gate 74 synchronizes the Zerocrossing signal to the PWM signal and gates the PWM signal to the switches Q71 and Q72 (Vsw is inverted by the invertor 73, before it is applied to the gate of Q71).

In other words, switches Q71 and Q72 control the phase of the current supplied to the lamp, and switches Q73 and Q74 control the phase of the voltage across the lamp. By aligning the phase of the current and the voltage, the power supplied to the lamp is optimized with respect to the total power consumption of the circuit. Therefore, the phasing between the current through and the voltage across the lamp are controlled (aligned) and thus the power phase is optimized in the lamp resulting in reduction of power consumption and increase in power efficiency.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention.

What is claimed is:

1. A method for driving a backlight lamp with a high voltage direct current (DC) source, the method comprising:
generating two complementary digital signals;
controlling a pair of switches by the two generated complementary digital signals;
applying a high DC voltage from the high voltage DC source to the lamp through the pair of switches; and
supplying a controllable current through the lamp.

2. The method of claim 1, further comprising applying a switching control signal; and controlling timing of the controllable current flowing through the lamp by the switching control signal.

3. The method of claim 2, further comprising applying a load control signal; and controlling phase of the voltage across the lamp by the load control signal.

4. The method of claim 3, wherein the controlling timing of the controllable current comprises aligning the timing of the controllable current to the timing of the high DC voltage polarity change across the lamp.

5. The method of claim 3, wherein applying a load control signal comprises applying two alternating high voltage sine waves to two loads, respectively.

6. A differential electronic circuit for driving a backlight lamp comprising:
a high voltage direct current (DC) source;
a controllable current source;
a pair of complementary digital signals;
a pair of differential switches controlled by the pair of complementary digital signals for providing a bidirectional current from the current source to the lamp; and
a pair of active loads couple to the pair of differential switches, respectively for providing an alternating voltage across the lamp responsive to the complementary digital signals.

7. The differential electronic circuit of claim 6, wherein each of the pair of active loads comprises an NMOS transistor and a high side N-FET driver.

8. The differential electronic circuit of claim 6, further comprising first and second capacitors for sensing zero crossing of the voltage polarity across the lamp; and a gate for generating a control signal based on timing of the lamp voltage polarity change to control timing of the controllable current flowing through the lamp.

9. The differential electronic circuit of claim 6, wherein the gate is one of a comparator and an AND gate.

10. The differential electronic circuit of claim 6, wherein the lamp is a Cold Cathode Fluorescent Lamp.

11. The differential electronic circuit of claim 6, wherein each of the pair of differential switches comprises an NMOS transistor.

12. The differential electronic circuit of claim 6, wherein the controllable current source is a digital to analog converter.

13. A differential electronic circuit for driving a backlight lamp comprising:
means for generating two complementary digital signals;
means for controlling a pair of switches by the two generated complementary digital signals;
means for applying a high DC voltage from the high voltage DC source to the lamp through the pair of switches; and
means for supplying a controllable current through the lamp.

14. The differential electronic circuit of claim 13, further comprising means for applying a switching control signal; and controlling timing of the controllable current flowing through the lamp by the switching control signal.

15. The differential electronic circuit of claim 13, further comprising means for applying a load control signal; and controlling phase of the voltage across the lamp by the load control signal.
